(19) United States
(12) Patent Application Publication
(10) Pub. No.: US 2003/0178391 A1
(43) Pub. Date: Sep. 25, 2003

(54) Composition for producing metal surface topography

(75) Inventors: Todd Johnson, Corona, CA (US); Michael C. Marsaglia, Phoenix, AZ (US); John Schemenaur, Tustin, CA (US)

Correspondence Address: EDWARDS & ANGELL, LLP, P.O. Box 9169, Boston, MA, 02209, US

(73) Assignee: Shipley Company, L.L.C., Marlborough, MA (US)

(21) Appl. No.: 10/421,293

(22) Filed: Apr. 23, 2003

Related U.S. Application Data
(62) Division of application No. 09/595,944, filed on Jun. 16, 2000.

(51) Int. Cl. C03C 25/68

(52) U.S. Cl. 216/105

(57) ABSTRACT

Compositions for micro-etching metal surfaces are disclosed. Also disclosed are methods for micro-etching metal surfaces. The compositions and methods disclosed are particularly useful in the manufacture of printed circuit boards.

### BACKGROUND OF THE INVENTION

The present invention is directed to printed circuit boards, particularly multi-layer printed circuit boards. In particular, the present invention is directed to micro-etching of metal printed circuitry to improve adhesion of the metal circuitry to resin layers of multi-layer circuit boards.

Successful fabrication of multi-layer printed circuit boards requires bonding together of metal layers, such as copper layers, and resin layers. In general, direct bonding of copper and resin layers does not provide sufficient bonding strength. It is common to improve metal to resin, particularly copper to resin, bonding strength by providing surface roughness to the metal surface, whereby mechanical bonding between the metal and resin is enhanced.

One common method of providing surface roughness of copper layers is by depositing on the copper surface an oxide layer, such as cuprous oxide, cupric oxide or the like. Formation of the oxide layer, which turns the pink copper surface a black-brown color, creates minute unevenness on the copper surface which provide an interlocking effect between the copper surface and resin, thus improving bonding strength.

One drawback is that copper oxides are readily degraded and dissolved upon contact with acid. Because various acid treatments are used in later stages of fabrication of multilayer circuit boards, oxide layer deposition has been problematic at best. For example, through-holes are drilled through multilayer circuit boards, and the through-holes plated with copper to interconnect the circuitry of the several layers. As part of the copper-plating process, the through-holes are exposed to acids, such as sulfuric acid. Acid attack on the oxide layer in the region surrounding the through-holes is commonly referred to in the industry as “pink ring”, due to the acid stripping the black-brown oxide layer from the surface, where a ring of bare pink copper becomes evident. The formation of such “pink ring” is detrimental at least to appearance and is a potential indication of a failure in multi-layer printed circuit boards. The problem of copper oxide vulnerability to acid has been approached in a number of patents, e.g., U.S. Pat. Nos. 4,642,161 and 4,717,439.

An alternative to building up a copper oxide coating on the copper surface is to micro-etch the copper surface to roughen it. Most commonly, this etching solution is an aqueous solution of a mineral acid, such as sulfuric acid, and an oxidant, such as hydrogen peroxide. An example of such etching solution is described in U.S. Pat. No. 4,751,106, the teachings of which are incorporated herein by reference. The micro-etching process roughens the copper such that the resulting topography on the metal surface provides better adhesion to subsequently applied resin layers. However, such conventional micro-etching processes suffer from providing insufficient adhesion for all subsequently applied resin layers.

There is thus a continuing need for micro-etched metal surfaces, particularly copper surfaces, that have improved adhesion to subsequently applied resin layers.

### SUMMARY OF THE INVENTION

It has been surprisingly found that the present invention provides metal surfaces, particularly copper surfaces, having enhanced surface topography, particularly deeper surface etching, so as to increase bond strength between the metal surfaces and subsequently applied polymeric materials in the manufacture of multilayer printed circuit boards.

In one aspect, the present invention provides a composition useful for micro-etching metal surfaces including one or more acids, one or more oxidants, one or more azole compounds and one or more sources of silver ions.

In a second aspect, the present invention provides a method for micro-etching a metal surface including the step of contacting the metal surface with a composition including one or more acids, one or more oxidants, one or more azole compounds and one or more sources of silver ions for a period of time sufficient to micro-etch the metal surface.

In a third aspect, the present invention provides a printed circuit board substrate including a micro-etched metal surface including silver.

In a fourth aspect, the present invention provides a method for manufacturing a printed circuit board including the steps of: a) contacting a metal surface disposed on a printed wiring board substrate with a composition including one or more acids, one or more oxidants, one or more azole compounds and one or more sources of silver ions to form a micro-etched metal surface; and b) subsequently applying a resin layer to the micro-etched metal surface.

### BRIEF DESCRIPTION OF THE DRAWINGS

FIG. 1 is a 5000× photo of a copper surface micro-etched with a comparative solution containing no silver ion.

FIG. 2 is a 5000× photo of a copper surface micro-etched with a solution of the invention.

### DETAILED DESCRIPTION OF THE INVENTION

As used throughout this specification, the following abbreviations shall have the following meanings unless the context clearly indicates otherwise: ppm=parts per million; wt %=percent by weight; v/v=volume/volume; and w/w=weight/weight.

The micro-etching process of the present invention is distinguished from processes in which portions of a copper layer are etched completely through such as to form circuitry traces of a printed circuit board. In micro-etching, no portion of copper, e.g., copper circuitry traces, are etched completely away; rather, the surface is etched or oxidized only to a limited extent so as to leave intact the original pattern of the copper being etched. Typically, the surface of the copper is etched by an oxidative process only to a depth of between about 20 and about 500 micro-inches as measured from the original surface to the depths of the micro-etching. This is accomplished by limiting the extent of etching by adjusting the concentrations, temperature, and the like of the etching solution or bath.

The terms “printed circuit board” and “printed wiring board” are used interchangeably throughout this specification. “Resin” and “polymer” are also used interchangeably.

As the major portion of printed circuitry is copper circuitry, the invention will be discussed herein in primarily in relationship to copper printed circuitry. In this regard, it is to be understood that there are a wide variety of possible processing steps in forming printed circuitry, and the invention, though described relative to a few common processing procedures, is generally applicable to providing increased surface topography roughness and optionally acid-resistance. It is preferred that the metal surfaces to be micro-etched according to the present invention are disposed on printed wiring board substrates, or are otherwise used in the manufacture of printed wiring boards.

The compositions useful in the present invention include one or more acids, one or more oxidants, one or more azole compounds, one or more sources of silver ions and water. Such compositions are useful in providing micro-etched metal surfaces, particularly for providing micro-etched metal surfaces disposed on printed wiring board substrates.

Any acid is useful in the compositions of the present invention, including organic acids and inorganic acids. The organic acids are typically strong organic acids. Suitable acids include, but are not limited to, hydrohalo acids such as hydrochloric acid, hydrobromic acid, hydrofluoric acid and hydroiodic acid, sulfuric acid, nitric acid, phosphoric acid, methane sulfonic acid, ethane sulfonic acid, propyl sulfonic acid, phenyl sulfonic acid, toluene sulfonic acid, and the like. Mixtures of acids may be advantageously used in the present invention. Preferred acids include sulfuric acid, nitric acid, phosphoric acid and mixtures thereof. Such acids are generally commercially available from a variety of sources, such as Aldrich (Milwaukee, Wis.), and may be used without further purification. The one or more acids are typically present in the compositions of the present invention in an amount of from about 0.1 to about 5 moles per liter, based on the composition, and preferably from about 0.25 to about 2.0 moles per liter. In general, the amount of acid in the present compositions is sufficient to provide a pH of about 4 or below.

Typically, any oxidant may be used in the present invention. Suitable oxidants include, but are not limited to, hydrogen peroxide, organic hydroperoxides such as tert-butyl hydroperoxide, persulfate compounds, ferric compounds, cupric compounds, nitric acid, and the like. Mixtures of oxidants may be used. Hydrogen peroxide is the preferred oxidant. Such oxidants are generally commercially available from a variety of sources, such as Aldrich (Milwaukee, Wis.), and may be used without further purification. Typically, the one or more oxidants are used in the compositions of the present invention in an amount of from about 0.2 to about 10 wt %, based on the total weight of the composition, preferably from about 0.5 to about 4 wt %. When hydrogen peroxide is used as the oxidant, it is typically present in an amount of from about 0.05 to about 3.5 moles per liter, and preferably from about 0.1 to about 1 moles per liter. It will be appreciated by those skilled in the art that nitric acid may be used as both the acid and the oxidant. Thus, when nitric acid is used as the oxidant, a second acid is optional. It is preferred that when nitric acid is used as the oxidant, that a second acid is used in the present compositions.

The compositions of the present invention also contain one or more azole compounds. While not intending to be bound by theory, it is believed that such azole compound provides enhanced differential etching and thereby better copper to resin adhesion. Any azole compound may be used in the micro-etching compositions of the present invention as long as the azole compound is compatible with the compositions and is at least partially water-soluble. Suitable azole compounds include, but are not limited to: triazoles such as benzotriazole, imidazoles, tetrazoles, thiazoles such as 2-mercaptobenzothiazole and 2-aminothiazole, and the like. It is preferred that the azole is a triazole or an imidazole, and more preferably selected from benzotriazole, tolyltriazole, carbxoxytriazole, imidazole and mixtures thereof. Benzotriazole is particularly suitable. Mixtures of azole compounds are also suitable. For example, a mixture of a triazole and an imidazole is contemplated by the present invention. The azole compounds may optionally be substituted. By “substituted azole” is meant the one or more hydrogens on the rings of the azole compounds may be replaced by another substituent group, such as (C₁-C₆)alkyl, (C₁-C₆)alkoxy, hydroxy, halo, and the like. “Halo” refers to fluoro, chloro, bromo and iodo. Such azole compounds are generally commercially, such as from Aldrich (Milwaukee, Wis.), and may be used without further purification. Additional suitable azole compounds are described, for example, in U.S. Pat. No. 3,770,530, herein incorporated by reference to the extent it teaches such azole compounds. Typically, the azole compounds are present in the compositions of the present invention in an amount of from at least about 0.02 wt %. The upper limit of the concentration of such azole compounds is the saturation limit of the compound in the composition. Suitable ranges of azole compounds are from about 0.02 to about 5 wt %, based on the weight of the composition, and preferably from about 0.1 to about 1 wt %.

A source of silver ions is also present in the compositions of the present invention. Any source of silver ions that is at least partially soluble in the present compositions is suitable. Typically, such sources of silver ions are silver salts, such as, but not limited to, silver nitrate. The silver ion source is typically present in an amount sufficient to provide from about 0.1 to about 100 ppm of silver ions, based on the weight of the silver ion, preferably from about 1 to about 50 ppm, and more preferably from about 2 to about 50 ppm.

The compositions of the present invention comprise water typically in an amount of about 40 wt % or greater. It will be appreciated that the balance by weight of the compositions of the invention is water. Deionized water is preferred.

The compositions of the present invention may optionally contain one or more additional components, such as, but not limited to, sulfur containing compounds, surfactants, organic solvents, organic polymers, and the like. Suitable sulfur containing compounds include, but are not limited to, thiocarbamides, such as thiourea. When such sulfur containing compounds are used in the present invention, the are typically present in an amount from about 0.01 wt % or greater, and preferably from about 0.1 wt % or greater. The upper limit of the concentration of such sulfur containing compounds is the saturation limit of the compound in the composition. While not intending to be bound by theory, it is believed that the sulfur containing compounds bond to the copper surface, for example, by chelation, and thereby render the copper and any copper oxide inaccessible to subsequent acid attack.

Suitable surfactants useful in the present invention include, but are not limited to, polyalkoxylated amines, sulfated and sulfonated amides, sulfated and sulfonated amines, glycerides and polyalkoxylated esters, betaines, and alcohols. When such surfactants are used, they are typically present in an amount of from about 0.05 to about 1 wt %, based on the weight of the composition. It will be appreciated that amounts of surfactant greater than about 1 wt % may be used in the present compositions.

Any water-miscible organic solvent may be used in the present invention. Suitable solvents include, but are not limited to, glycols, glycol ethers, glycol ether acetates, esters, ketones, alcohols, and the like. Mixtures of organic solvents may also be advantageously used. When such water-miscible solvents are used, they are typically present in an amount of from about 0.1 to about 10 wt %, and preferably from about 0.5 to about 2.5 wt %.

When an organic polymer is used in the present compositions, it is typically present in an amount of from about 25 ppm to about 10,000 ppm. Suitable organic polymers include, but are not limited to, ethylene oxide, ethylene oxide-propylene oxide copolymers, polyethylene glycols, polyproplylene oxide copolymers, polyethylene glycols, polyproplyene glycols, polyvinyl alcohols, and mixtures thereof. It is preferred that such organic polymers are at least partially water-soluble or water-dispersible. It is further preferred that one or more organic solvents are used when one or more organic polymers are used. Such solvents may aid in solubilizing the organic polymers.

The compositions of the present invention are prepared by combining the one or more acids, one or more oxidants, one or more azole compounds, one or more sources of silver ions, water and any optional additional components in any order. If there are water solubility issues with one or more compounds, the addition order may be modified as needed to ensure full or at least partial solubility of all components.

Metal surfaces, particularly copper surfaces, may be micro-etched by contacting the metal surfaces with the compositions of the present invention. The metal surfaces may be contacted with the present compositions by any means, such as immersion, spraying and the like. It is preferred that the metal surface is disposed on a printed wiring board substrate. It is further preferred that the metal surface is a copper surface.

In general, the baths of the present invention may be used at a variety of temperatures, such as from about 10° C. to about 70° C. It is preferred that the temperature of the bath is from about 15° C. to about 45° C.

Depending upon the degree of micro-etching required, the time the metal surfaces are contacted with the present etchant compositions may vary across a wide range. For example, the metal surfaces may contact the compositions of the present invention from about 0.1 to about 10 minutes, and preferably from about 0.25 to about 3 minutes.

The metal surface is oxidatively micro-etched upon contact with the present compositions. During such micro-etching, silver is deposited on the topography created by the micro-etching, thereby increasing the irregularity of the surface topography. Such silver deposit has the advantage of protecting the surface against acid attach during subsequent processing, thereby helping to minimize “pink ring” formation. In addition to its function, the silver produces a darkened finish to the etched surface, an appearance favored by manufacturers of printed circuit boards.

The compositions of the present invention may also be used to deposit an immersion silver coating. For example, as the concentration of silver ions is increased above about 25 ppm, the present compositions provide a significant level of silver immersion deposit on the copper surface as evidenced by a silver hue. In such immersion silver baths, a silver coating is deposited and the resulting surface does not necessarily show sufficient roughening or micro-etching to provide sufficient adhesion to subsequent resin layers. Thus, the present invention also provides a method for preparing an immersion silver coating including the step of contacting a metal surface with a composition including one or more acids, one or more oxidants, one or more azole compounds and one or more sources of silver ions, wherein the concentration of silver ions in the composition at least about 25 ppm.

The following examples are intended to illustrate further various aspects of the present invention, but are not intended to limit the scope of the invention in any aspect.

### EXAMPLE 1

### (Comparative)

A conventional micro-etch bath was prepared by combining: 5.5% v/v sulfuric acid (98% w/w), 3% v/v hydrogen peroxide (50% w/w) and 2.5 g/L benzotriazole.

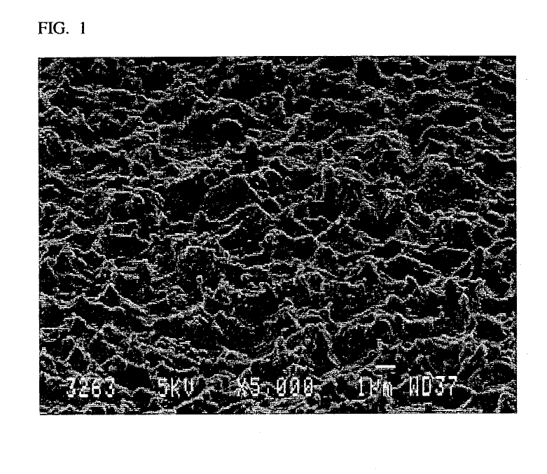

A copper foil sample was chemically pre-cleaned. The sample was then micro-etched in the bath for 2 minute at ambient temperature. FIG. 1 is a photomicrograph of the micro-etched surface of the copper foil. The copper foil sample was then laminated to pre-preg epoxy material. The peel strength of the laminated structure was determined to be 1.8 pounds/inch.

### EXAMPLE 2

A micro-etch bath according to the present invention was prepared by combining 5.5% v/v sulfuric acid (98% w/w), 3% v/v hydrogen peroxide (50% w/w), 5 g/L benzotriazole and 0.015 g/L silver nitrate (9.5 ppm silver ion).

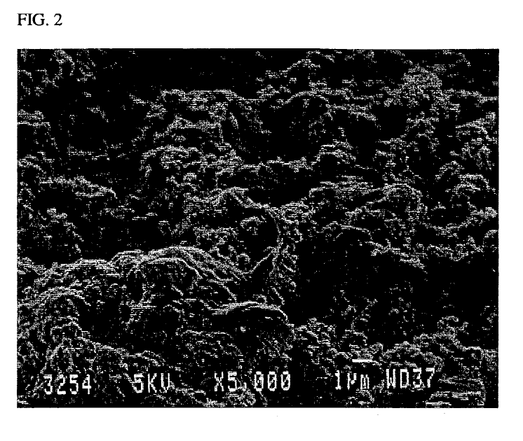

A copper foils sample was chemically pre-cleaned. The sample was then micro-etched in the bath for 2 minute at ambient temperature. FIG. 2 is a photomicrograph of the micro-etched surface of the copper foil. As can be seen, the micro-etched topography of FIG. 2 is substantially deeper than that of the comparative FIG. 1.

The copper foil sample was then laminated to pre-preg epoxy material. The peel strength of the laminated structure was determined to be 4.2 pounds/inch. As can be seen from the data, the peel strength of the laminated structure of this example was much greater than the peel strength of material structure on comparative Example 1.

What is claimed is:

1. A composition useful for micro-etching metal surfaces comprising one or more acids, one or more oxidants, one or more azole compounds and one or more sources of silver ions.

2. The composition of claim 1 having a pH of about 4 or below.

3. The composition of claim 1 wherein the one or more oxidants are present in an amount of from about 0.2 to about 10 wt %.

4. The composition of claim 1 wherein the oxidant is selected from hydrogen peroxide, organic hydroperoxides, persulfate compounds, ferric compounds, cupric compounds or nitric acid.

5. The composition of claim 1 wherein the oxidant is hydrogen peroxide.

6. The composition of claim 1 wherein the one or more acids are present in an amount of from about 0.1 to about 5 moles per liter.

7. The composition of claim 1 wherein the one or more acids are selected from hydrochloric acid, hydrobromic acid, hydrofluoric acid and hydroiodic acid, sulfuric acid, nitric acid, phosphoric acid, methane sulfonic acid, ethane sulfonic acid, propyl sulfonic acid, phenyl sulfonic acid or toluene sulfonic acid.

8. The composition of claim 1 wherein the one or more azole compounds are selected from triazoles, imidazoles, tetrazoles or thiazoles.

9. The composition of claim 8 wherein the one or more azole compounds are selected from benzotriazole, tolyltriazole, carbxoxytriazole, imidazole, 2-mercaptobenzothiazole or 2-aminothiazole.

10. The composition of claim 1 wherein the one or more azole compounds are present in an amount of at least about 0.02 wt %, based on the weight of the composition.

11. The composition of claim 1 wherein the one or more sources of silver ions is present in an amount sufficient to provide from about 0.1 to about 100 ppm of silver ions in the composition.

12. The composition of claim 1 further comprising one or more additional components selected from sulfur containing compounds, surfactants, organic solvents or organic polymers.

13. A method for micro-etching a metal surface comprising the step of contacting the metal surface with a composition of claim 1 for a period of time sufficient to micro-etch the metal surface.

14. The method of claim 13 wherein the metal surface is a copper surface.

15. The method of claim 13 wherein the one or more sources of silver ions is present in an amount sufficient to provide from about 0.1 to about 100 ppm of silver ions in the composition.

16. The method of claim 13 wherein the one or more azole compounds are selected from benzotriazole, tolyltriazole, carbxoxytriazole, imidazole, 2-mercaptobenzothiazole or 2-aminothiazole.

17. The method of claim 13 wherein the metal surface is disposed on a printed wiring board substrate.

18. A printed circuit board substrate comprising a micro-etched metal surface comprising silver.

19. A method for manufacturing a printed circuit board comprising the steps of: a) contacting a metal surface disposed on a printed wiring board substrate with a composition comprising one or more acids, one or more oxidants, one or more azole compounds and one or more sources of silver ions to form a micro-etched metal surface; and b) subsequently applying a resin layer to the micro-etched metal surface.

20. The method of claim 19 wherein the metal surface is a copper surface.
